(19) United States
(12) Patent Application Publication
(10) Pub. No.: US 2024/0207118 A1
(43) Pub. Date: Jun. 27, 2024

(54) MANUAL WHEELCHAIR HAVING INTEGRATED MOTOR HOUSING AND CAMBER TUBE STRUCTURE

(71) Applicant: Sunrise Medical (US) LLC, Fresno, CA (US)

(72) Inventors: Timothy Raiskup, Clovis, CA (US); Benjamin Anooshian, Fresno, CA (US)

(73) Assignee: Sunrise Medical (US) LLC, Fresno, CA (US)

(21) Appl. No.: 18/524,804

(22) Filed: Nov. 30, 2023

Related U.S. Application Data
(60) Provisional application No. 63/434,303, filed on Dec. 21, 2022.

(51) Int. Cl. A61G 5/10; A61G 5/04

(52) U.S. Cl. CPC A61G 5/1097; A61G 5/041

(57) ABSTRACT

A manual wheelchair has a camber tube that supports manual drive wheels for rotation relative to a wheelchair frame. A pair of drive motors are housed within the camber tube and connect to an axle shaft supported within a wheel hub. The axle shaft has a distal end defining an angle accommodating and torque-transmitting profile that connects to the drive motor. The axle shaft has a proximal end defining a torque transmitting connection with a drive disconnect assembly that selectively permits engagement of the drive motor to the wheel hub. The axle shaft supports a retaining ball and an actuator to permit the drive wheel to be removed from the wheelchair. The drive disconnect assembly permits the motor to be mechanically disconnected from the wheel hub to reduce drag and friction when the wheelchair is operated manually.

### CROSS-REFERENCE TO RELATED APPLICATIONS

This application claims the benefit of U.S. Provisional Application No. 63/434,303, filed Dec. 21, 2022, the disclosure of which is incorporated herein by reference in its entirety.

### BACKGROUND OF THE INVENTION

This invention relates in general to power assist drive units for manual wheelchairs. In particular, this invention relates to structurally integrated drive-assist units for manual wheelchairs.

Manual wheelchairs provide a degree of freedom and independence for users with limited mobility. The overall utility of a manual wheelchair is related to a user's ability to propel the unit and their endurance level. In situations where users have limited upper body strength or lowered endurance levels, powered drive-assist units can extend the range and usefulness of a manual wheelchair for a fraction of the cost and transport weight of a conventional, power-driven wheelchair. Typical power assist units attach to a wheelchair in a push or a pull configuration. Pull-type units often include a bicycle-style or scooter-style steering and drive system that attaches to the front frame or front caster wheels of a manual wheelchair. These units tend to be large and increase the overall wheelbase or footprint of a manual wheelchair, making them more difficult to maneuver in space-restricted environments. These units often include cumbersome attachment hardware that can create obstacles for users to configure the chair from a manual to a power-assisted mode.

Push-type units typically mount to the rear structure, frame or axle tube, of the manual wheelchair and can be more easily detached from the chair. These units may also have a suspension component that permits the push-type drive to follow ground contours without transferring vertical force reactions to the frame and user. The push-type drive suspension may also permit the user to engage obstacles in a familiar manual wheelchair mode, such as elevating the front wheels to overcome a curb, i.e., popping a wheelie. While these units are more easily detachable from the wheelchair structure, they do extend rearwardly making detachment somewhat difficult for a seated user. They also increase the footprint or wheelbase and affect negotiating maneuvers in tight environments.

Other known power-assist drive units include motors that directly engage the large drive wheels of manual wheelchairs. These units may be frame mounted and frictionally engage the drive wheels or may be hub-mounted. Frictional drive units also include mounting hardware that may be cumbersome to connect and release. In addition, frictional drives tend to increase tire wear and may expel debris captured in the tire tread. Hub-mounted drives provide a decreased footprint and improve negotiations in tight spaces but may increase rolling resistance when operated as in manual mode. These units may also have an involved detachment process in order to convert a manual chair for transport. What is needed is a power-assist drive unit for manual wheelchairs that generally maintains the manual chair wheelbase and aesthetics, provides easy conversion to a transport configuration, and includes a freewheeling mode that reduces drag associated with the power drive rotating mass.

### SUMMARY OF THE INVENTION

This invention relates to power assist drive units for manual wheelchairs. In particular, this invention relates to structurally integrated drive-assist units and drive wheel camber tubes for use in manual wheelchairs.

In certain embodiments, the wheelchair comprises a frame and a camber tube attached to the frame. The camber tube defines a hollow section that supports at least one drive motor. In certain aspects of the invention, the at least one drive motor is supported within the hollow section, and alternatively the at least one drive motor may partially extend out of the camber tube. The at least one drive motor has an output connected to a wheel hub supporting a wheelchair drive wheel.

In certain embodiments of the wheelchair, the wheel hub includes a release housing defining a hub drive profile. A drive ring defines a wheel drive zone that selectively engages the hub drive profile to transmit power from the at least one drive motor to the wheel hub. The drive ring is connected to a transfer ring by at least one actuator link. The transfer ring can be selectively actuated by a control knob to move the drive ring between an engaged position where the wheel drive zone transfers power from the motor to the wheel hub and a disengaged position where the motor output is mechanically decoupled from the wheel hub. In certain configurations, the actuator link is integrally connected to the transfer ring. In certain other configurations, the transfer ring includes a drive pin that engages the actuator link. The transfer ring may include at least one drive wedge having a tapered profile. The control knob includes mating actuation recess having a complementary tapered profile to the at least one drive wedge. In other configurations, the transfer ring may include at least one drive pin that engages a corresponding angled slot in the control knob. In certain aspects, a resilient member may be provided to bias the transfer ring into the engaged position.

The wheelchair may have the motor output coupled to a drive collar that defines a drive engagement zone having a torque transmitting profile and the drive ring defines a drive ring bore having a complementary torque transmitting profile. The drive ring drive engagement zone selectively engages the drive collar to transmit power from the motor to the wheel hub. The drive collar further defines a freewheel zone that mechanically decouples the motor output from the wheel hub. An axle shaft engages the motor output and defines a proximal end having a torque transmitting profile that engages the drive collar and a distal end that connects to the motor output. In certain embodiments, the axle shaft distal end defines a torque transmitting profile having leading and exiting tapers that are configured to accommodate a relative angle between the axle shaft and the motor output. In certain aspects of the invention, the axle shaft distal end defines a quick-release actuator comprising a ball that engages a detent to permit the axle shaft and wheel hub to be removed from the motor and camber tube. Certain embodiments are configured to permit adjustment of the drive wheel camber angle relative to the wheelchair frame. In those embodiments, the camber tube supports a camber block configured to define a camber angle between the wheel hub and the camber tube. The camber block includes a pilot that locates relative to a motor tail housing mounted within the camber tube. The camber block includes a camber bore that orients at least one support bearing to establish the camber angle and orient the axle shaft to the camber angle.

The wheelchair according to the invention has the at least one drive motor electrically connected to a power pack for providing a source of electrical power. The power pack is configured to slide into a battery slot of a docking station. The docking station may be mounted underneath the wheelchair at an angle sloping from the rear end downwardly toward the front end of the wheelchair. The battery slot includes a contact port configured to make an electrical connection between the power pack and a wheelchair electrical system. An ejector is configured to resiliently bias the power pack toward a disconnected state where no electrical connection is formed with the wheelchair electrical system.

The wheelchair comprises a frame and a camber tube defining a hollow section is attached to the frame. At least one drive motor is supported within the hollow section and includes an output engaged with an axle shaft at a distal end thereof. The axle shaft has a proximal end defining a torque transmitting profile that engages a wheel hub to transmit a rotary output of the drive motor to the wheel hub. A coupling is connected to the motor output and has a torque-transmitting profile that engages with a mating torque-transmitting profile of the axle shaft distal end. The mating torque-transmitting profile is configured with an apex, a leading taper and an exiting taper that permits an angular adjustment or deviation of the axle shaft relative to the output shaft. One of the axle shaft proximal end or axle shaft distal end defines a quick-release attachment configured as a ball and detent that is configured to release the wheel hub from the wheelchair.

In other embodiments of the invention, the wheelchair has a frame and a camber tube attached to the frame. The camber tube supports at least one drive motor having an output. A wheel hub supports a drive wheel for rotation relative to the frame. The wheel hub has a hub drive profile connected to the drive motor output by a drive ring that is configured for selectively engaging the hub drive profile to transmit power from the at least one drive motor to the drive wheel. The drive ring is moved by a control knob between an engaged position where the drive motor power rotates the drive wheel and a disengaged position where the drive wheel is mechanically disconnected from and freely rotates relative to the at least one drive motor.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a manual wheelchair having a power-assist drive unit in accordance with the invention.

FIG. 2 is a rear elevation view of the manual wheelchair of FIG. 1.

FIG. 3 is a cross-sectioned view of the manual wheelchair of FIG. 2.

FIG. 4 is an enlarged, elevation view, in cross-section, of a portion of the motor drive assembly and wheel end module of the power-assist drive unit of FIG. 3.

FIG. 5 is an enlarged, cross-sectional view of an angle-accommodating drive member assembly of the wheel end module of FIG. 4.

FIG. 6 is an enlarged, cross-sectional view of the angle accommodating drive member assembly articulated at an angular position.

FIG. 7 is an enlarged, cross sectional view of a drive disconnect in the power-assist drive unit in accordance with the invention.

FIG. 8 is an exploded view of the drive disconnect of FIG. 7

FIG. 9A is a perspective view of an alternative embodiment of a freewheeling hub disconnect in accordance with the invention.

FIG. 9B is an enlarged, perspective view, in cross section, of the freewheeling hub disconnect of FIG. 9A.

FIG. 10A is an exploded view of the freewheeling hub disconnect of FIG. 9A.

FIG. 10B is an enlarged, cross sectional view of a hub of the freewheeling hub disconnect of FIG. 10A.

FIG. 11 is a rear perspective view of a power module associated with the power-assist drive unit of FIG. 1.

FIG. 12 is an elevational view, in cross-section, of the power module of FIG. 7.

### DETAILED DESCRIPTION OF THE PREFERRED EMBODIMENT

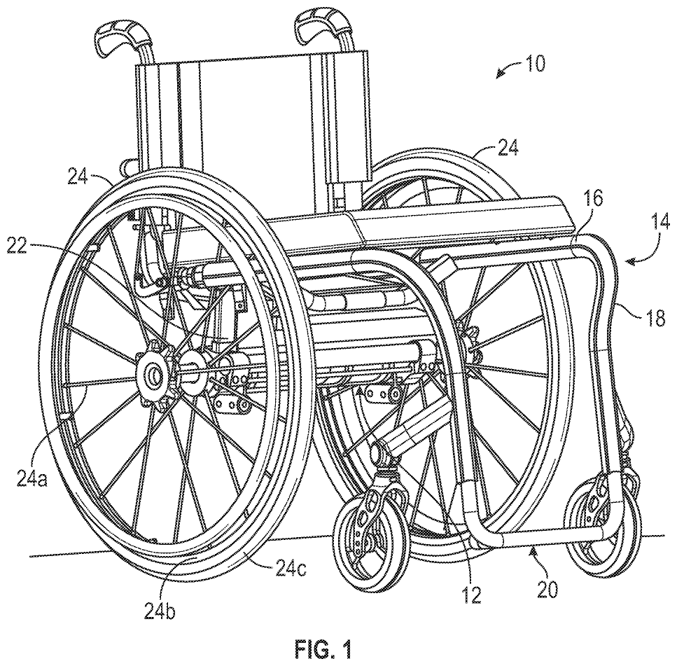

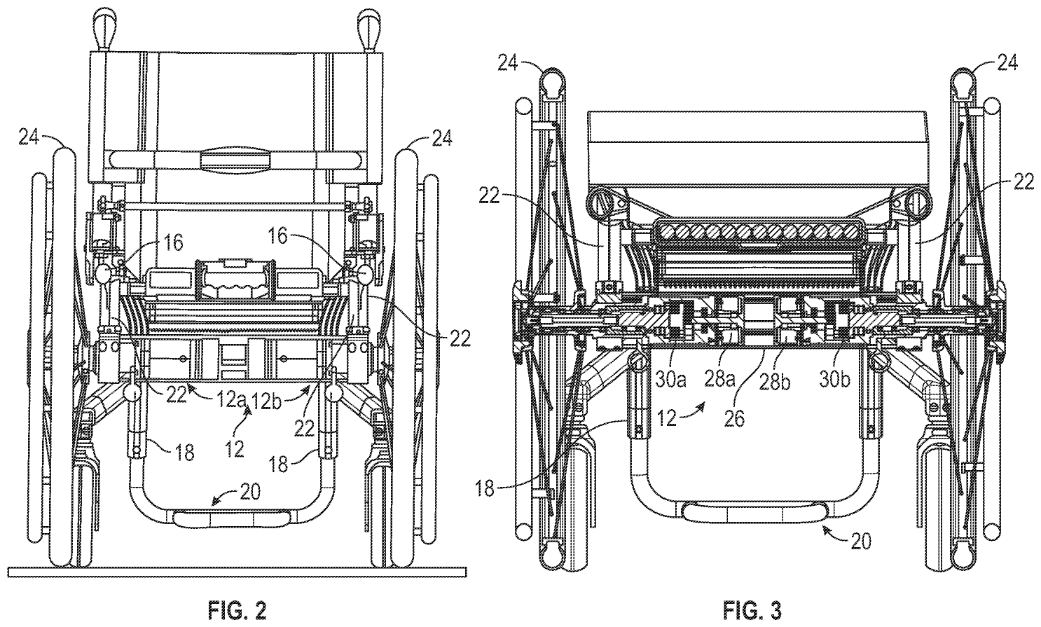

Referring now to the drawings, there is illustrated in FIGS. 1-3 a manual wheelchair, shown generally at 10, that includes a power-assist drive unit, shown generally at 12. The manual wheelchair 10 is illustrated as a lightweight, rigid frame chair though other designs including open frame, dual tube frame, or folding frame manual chairs are contemplated within the scope of this invention. A wheelchair frame 14 includes seat support tubes 16, illustrated as spaced-apart longitudinal tubular members, that transition into downleg tubes 18, illustrated to support caster wheel assemblies. The downleg tubes 18 support a footplate crossbar and footplate assembly 20. Right and left mounting arms 22 extend from the seat support tubes 16 and engage the power-assist drive unit 12. Left and right drive wheels 24 are attached to output structures of the drive unit 12, as will be described below in detail. In prior art rigid wheelchair frames, axle tubes configured similarly to the mounting arms 22 support a camber tube that extends between the left and right drive wheels. The camber tubes support adjustment plates that permit the camber angles of the drive wheels to be varied relative to the frame.

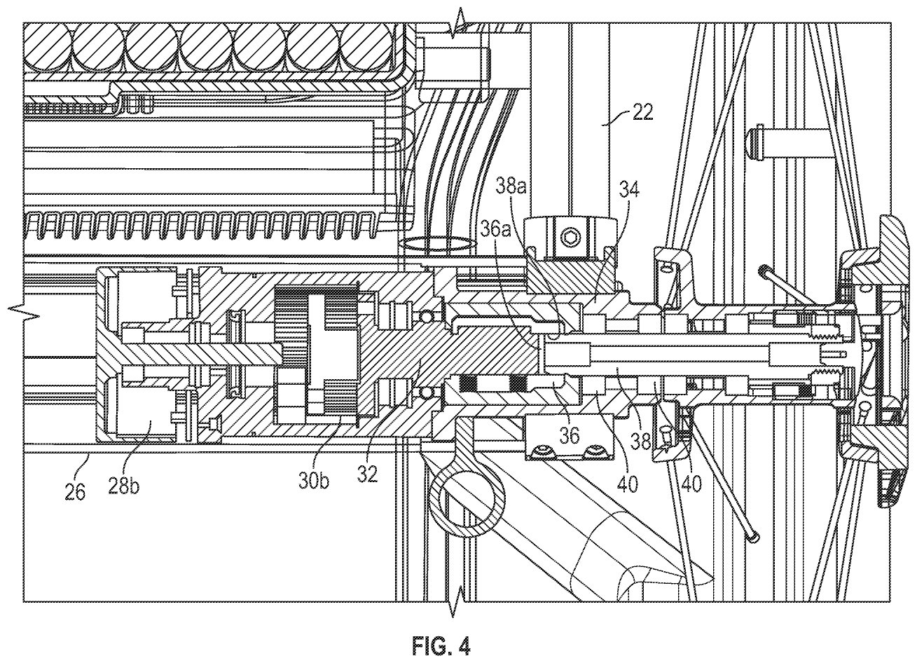

Referring now to FIGS. 3 and 4, the power-assist drive unit 12 includes an outer housing 26, configured as a camber tube, that houses left and right drive units 12a and 12b. The drive units 12a, 12b include left and right electric motors 28a and 28b, and may further include left and right gear trains 30a and 30b. The gear trains 30a, 30b may be gear trains or transmissions to adjust motor output parameters to application needs, for example lowering motor speed and increasing output torque. The electric motors 28a,b may be configured as any type of electric motor such as, for example, DC brushed or brushless, AC, variable reluctance, induction, and others. The gear train 30a,b are illustrated as planetary gear trains but may be any style or orientation of gear elements to create the desired output from a given input. The electric motors 28a, 28b and gear trains 30a, 30b are illustrated being arranged in a longitudinal and coaxial orientation within the camber tube housing 26.

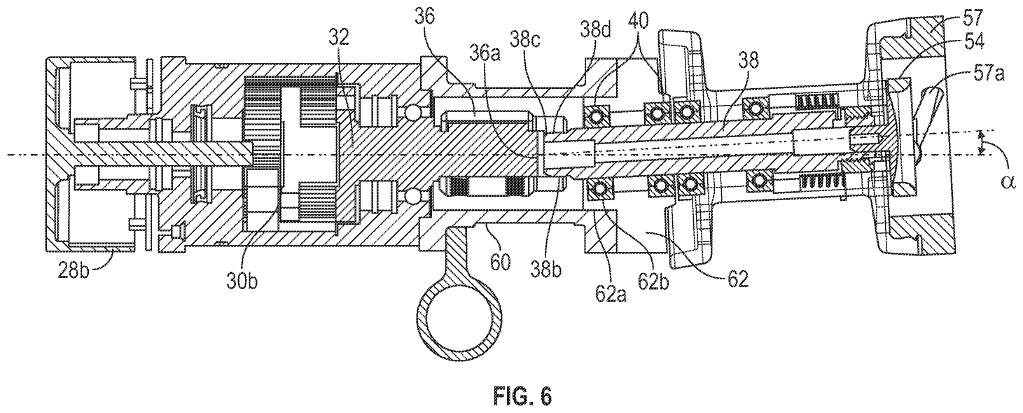

As shown in FIGS. 4-6, an output shaft 32 is connected to and extends from each of the gear trains 30a, 30b defining a motor output extending into a motor tail housing 34. The motor tail housings 34 extend from the camber tube housing 26 and are supported on the frame 14 by the mounting arms 22. In the illustrated embodiment, a coupling 36 is fixed to the output shaft 32 and defines a torque-transmitting profile 36a that engages an axle shaft 38. Alternatively, the coupling may be integrally formed with the output shaft 32. The axle shaft 38 is supported within the motor tail housing 34 by bearings 40. The axle shaft 38 has a distal end 38a defining a mating torque-transmitting profile 38a that is configured to mate with the corresponding torque-transmitting profile 36a of the coupling 36. The distal end mating torque-transmitting profile 38a is configured with an apex 38b and leading and exiting tapers 38c and 38d that permit an angular adjustment or deviation of the axle shaft 38 relative to the output shaft 32. This permits adjustment of a camber angle of the drive wheels 24 as shown in FIG. 6 and described below in detail. The axle shaft 38 has a proximal end 38e defining a second torque-transmitting profile that selectively engages a drive disconnect assembly, shown generally at 42. The proximal end 38e further includes a retainer 38f configured as a detent ball selectively engaging a detent formed in the coupling 36 or other component to retain the axle shaft 38 within the drive unit 12a/12b, as will be explained below.

The axle shaft 38 extends through a wheel hub 44 that is part of the wheel 24 and the drive disconnect assembly 42. The wheel hub 44 includes opposing spoke flanges 44a and 44b that are attached to spokes 24a, which may be configured as a plurality of wire spokes or a wheel disk, which support a wheel rim 24b and tire 24c. The hub 44 includes a release housing 44c illustrated as a hollow member extending between the opposing spoke flanges 44a and 44b. The release housing 44c includes a freewheel lock 46, illustrated as an “L” shaped aperture, that defines an engaged position 46a and a disengaged position 46b. The engaged position 46a enables power to be transferred from the drive motor to the drive wheel. The disengaged position 46b includes a detent to maintain the drive disconnect assembly in the disengaged position and mechanically disconnects the drive wheel from the drive motor. When disconnected, a freewheeling condition of the drive wheel is established that reduces drag when manually propelling the wheelchair, thus reducing user fatigue.

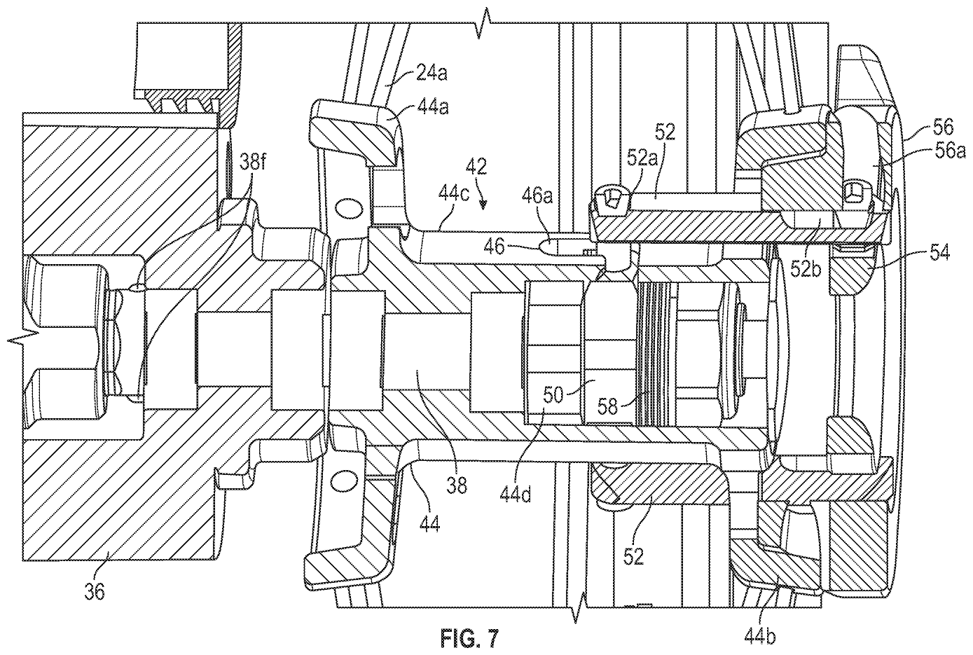

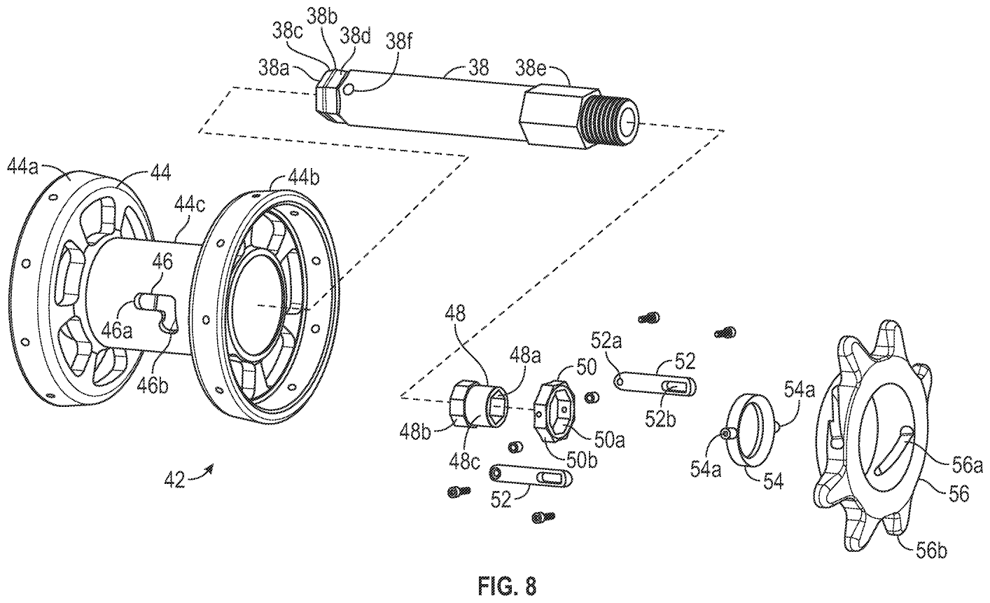

The drive disconnect assembly 42 includes a drive collar 48 having a bore 48a defining a torque-transmitting profile that engages the second torque-transmitting profile of the proximal end 38e of the axle shaft 38. The drive collar 48 has an outer profile defining a drive engagement zone 48b and a freewheel zone 48c. The drive engagement zone 48b is a torque-transmitting profile that selectively engages with a drive ring 50 having a mating profile in a drive ring bore 50a. The drive collar freewheel zone 48c defines a clearance between the drive ring bore 50a and the drive collar 48 such that the wheelchair drive wheels 24 rotate freely relative to the output shaft 32. In the illustrated embodiment, the freewheel zone 48c is a cylindrical section having a diameter that is smaller than a minor spline diameter or diameter of the flat side profile of the drive engagement zone 48b or the drive ring bore 50a. In the disengaged position, the drive collar 48 is moved over the freewheel zone 48c to mechanically decouple the drivewheel 24 from the drive motors 28a,b. The drive ring 50 also has a wheel drive zone 50b defining a torque-transmitting profile on the outer diameter that selectively engages a hub drive profile 44d within the hollow region of the hub 44 as shown in FIG. 7. The hub drive profile 44d aligns at least with the drive engagement zone 48b of the drive collar 48 so that when the drive ring 50 is moved toward the engaged position 46a the hub drive profile 44d engages the wheel drive zone 50b and the drive ring bore 50a engages the drive engagement zone 48b. In this position, torque is transmitted from the drive motor through the axle shaft 38 to the proximal end 38e and then to the drive collar 48. From the drive collar 48, torque is transferred through the drive ring 50 to the hub 44 to power the drive wheels 24.

The drive ring 50 is attached to actuator links 52 connected to a transfer ring 54 that engages a control knob 56. The actuator links 52 have a distal end 52a that attaches to the drive ring 50 by bolts, pins, screws or other attachment means. A proximal end 52b includes slots that receive drive pins 54a extending from the transfer ring 54. A resilient member 58, for example a coil spring, applies a force in the engagement direction of the drive ring 50. The pins 54a of the transfer ring 54, or fasteners attaching the links 52 to the transfer ring 54, engage actuation slots 56a in the control knob 56 to axially move the transfer ring toward or away from the engaged position. The slots of the proximal end 52b of the actuator links 52 permit the transfer ring 54 to be moved toward engagement and the resilient member 58 to move the drive ring 50 into engagement with the hub drive profile 44d and the drive engagement zone 48b of the drive collar 48 when the torque-transmitting profile are aligned. The actuation slots 56a of the control knob 56 are helical slots with a helical profile defining opposing sides of the slot and at least extending into the control knob 56, but may also extend through the knob. Rotation of the knob 56 causes the transfer ring 54 to move axially. The control knob 56 further includes a grip profile illustrated as a plurality of grip teeth or protrusions 56b that enables easier actuation for users with limited dexterity or range of movement. As shown in FIG. 6, a control knob 57 is configured with actuation slots 57a, similar to slots 56a. The illustrated control knob 57 has a grip profile 57b that may be smooth, knurled, or otherwise textured but without grip teeth or other assistive protruding profiles. In an alternative embodiment, the control knob may make or break an electrical contact to power an electro-magnet or other actuator to move the drive ring into and out of engagement with the hub drive profile.

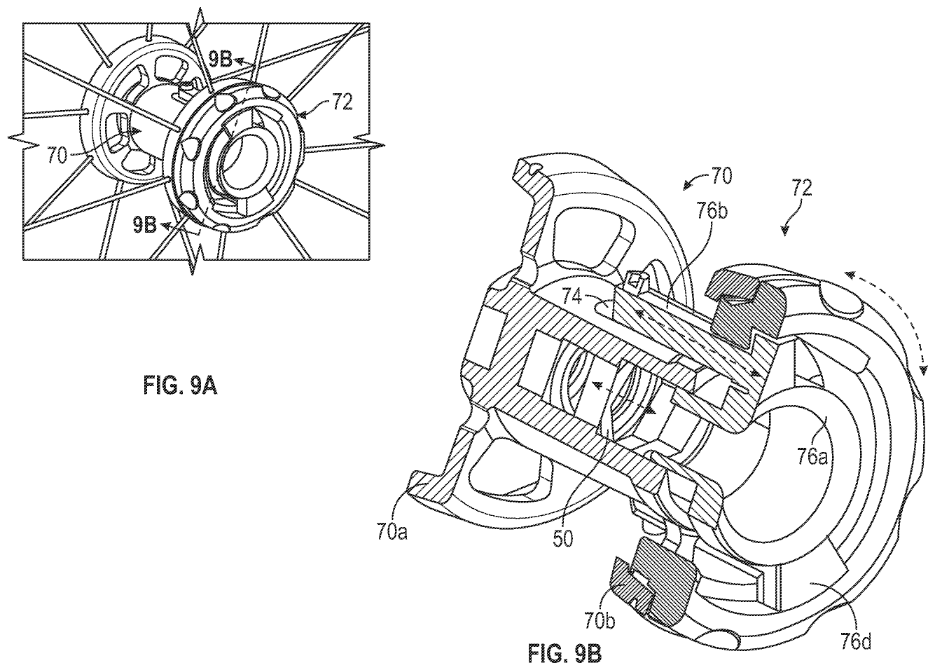

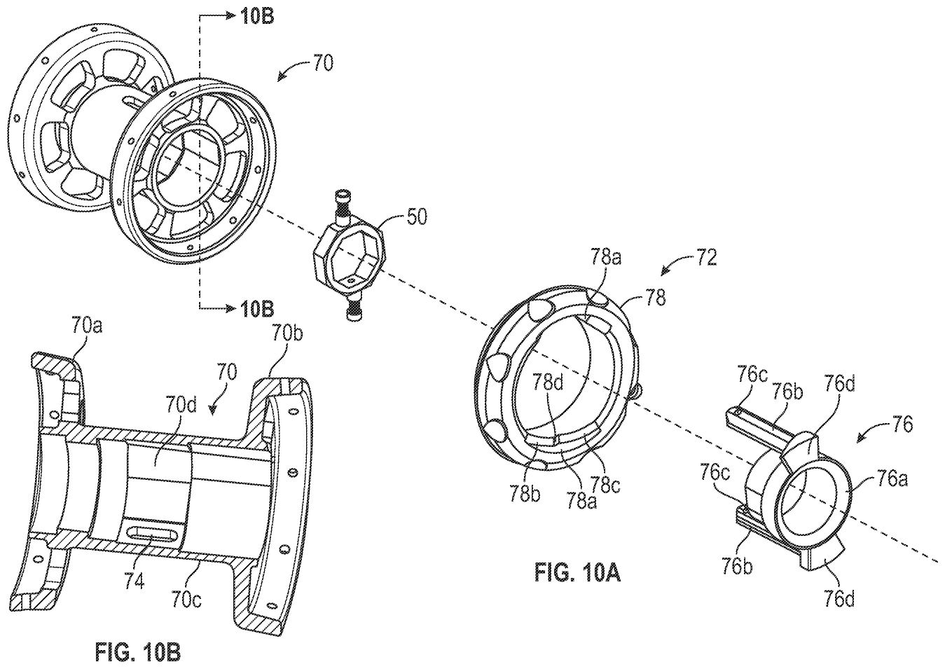

Referring now to FIGS. 9A-10B, there is illustrated an alternative embodiment of a hub 70 and a drive disconnect assembly 72 that selectively shifts the drive wheel 17 between the disconnected, freewheeling mode and the engaged, driving mode. The hub 70 is configured similarly to hub 44, described above, and includes spoke flanges 70a and 70b, a release housing 70c, and a hub drive profile 70d. The hub 70 includes a guide slot 74 rather than the freewheel lock 46 of hub 44. A transfer assembly, shown generally at 76, includes a transfer ring 76a with integrally formed actuator links 76b that extend axially and have attachment apertures 76c at a distal end that engage the drive ring 50 similar to links 52. The transfer assembly 76 includes drive wedges 76d that have a tapered profile. A control knob 78 includes actuation recesses 78a, similar in function to actuation slots 56a to permit axial movement of the transfer assembly 76. The actuation recesses 78a have a profile on one side and open on the opposing side rather than similarly configured opposing sides as in slots 56a. The open side of the actuation recess 78a functions in a similar manner to proximal end slots 52b and permits the transfer assembly 76 to remain in the disengaged position until the drive surfaces of the hub 70 and drive ring 50 align and engage. The actuation recess 78a defines a two-step profile having an engagement seat 78b and a disengagement seat 78c separated by a retaining detent 78d. The engagement and disengagement seats 78b and 78c are illustrated as taper profiles that are complementary to the tapered profile of the drive wedges 76d. Alternatively, these seat profiles may be configured as straight or flat steps.

When the control knob 78 is rotated from the disengaged position shown in FIG. 9B to the engaged position, illustrated as a counterclockwise rotation, the drive wedges 76d move off of the disengagement seats 78c toward the engagement seats 78b. If the hub drive profile 70d is aligned with the wheel drive zone 50b of the drive ring 50, the resilient member 58 moves the two hex features into engagement. If the hub drive profile 70d and the wheel drive zone 50b are not aligned, as the wheel rotates the two features are brought into alignment and permit engagement. The heads of attaching bolts move in the guide slot 74 to maintain alignment and reduce engagement loads.

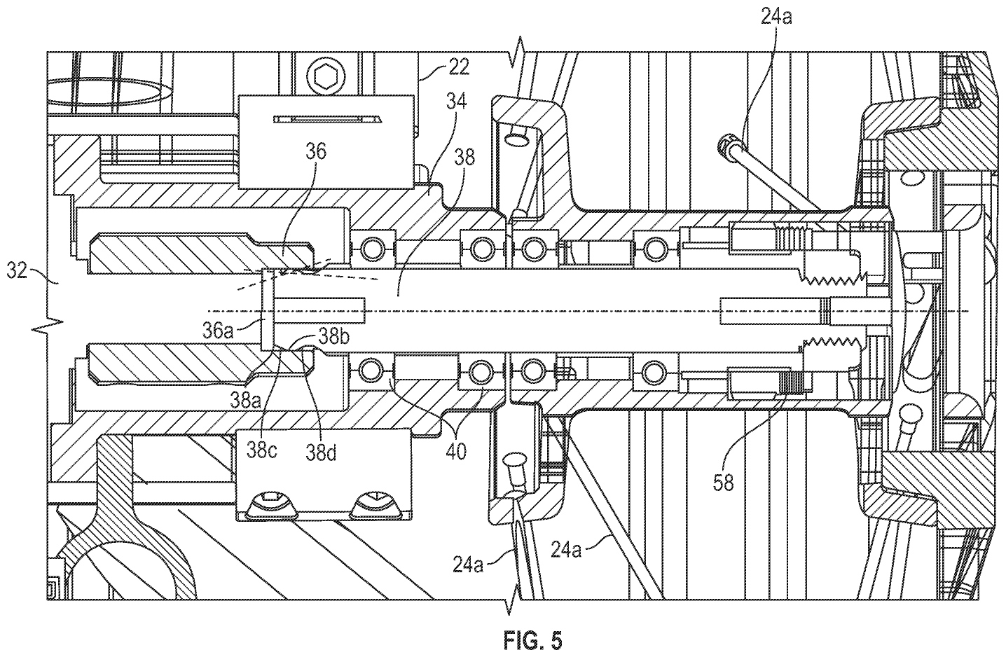

Referring now to the embodiment of FIG. 6, the motor tail housing 34 of FIG. 5 may be configured as a two piece structure including a motor tail housing 60 that is engaged by the mounting arms 22 and a camber block 62. The camber block 62 includes support bearings 40 but is formed to create a camber angle, α, when attached to the motor tail housing 60. As shown in FIG. 6, the camber block 62 has a pilot 62a that locates relative to the motor tail housing 60 and a camber bore 62b that establishes the desired camber angle in conjunction with the support bearings 40 that hold and orient the axle shaft 38. Several camber blocks 62 may be provided in order to change the camber angle, α, to the desired orientation.

The hub 44 may also include a quick-release connection to separate the drive wheels 24 from the drive unit 12 without requiring tools. The quick-release connection may be a ball and detent attachment that retains the hub onto the axle shaft. The hub 44 and the attendant drive disconnect assembly 42 can be separated from the axle shaft 38 or may retain the axle shaft and be separable from the motor tail housing and camber block or separable from the coupling 36.

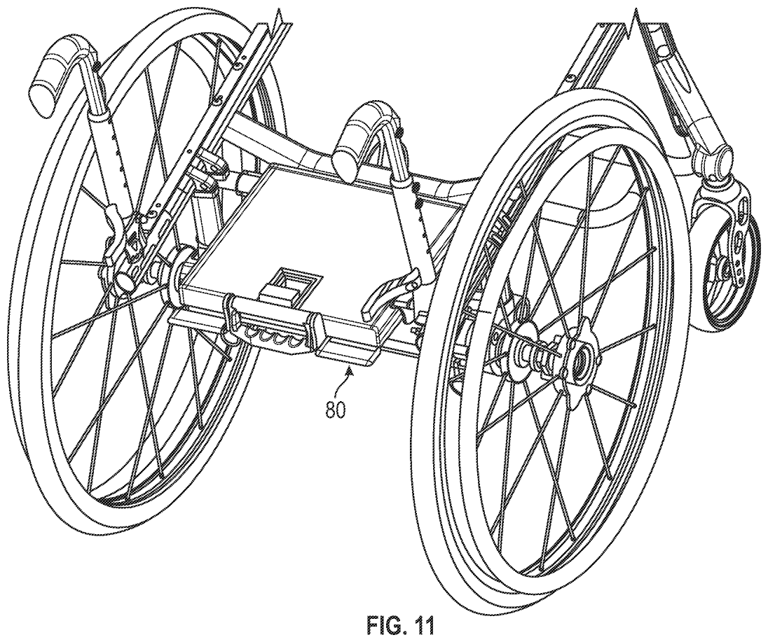

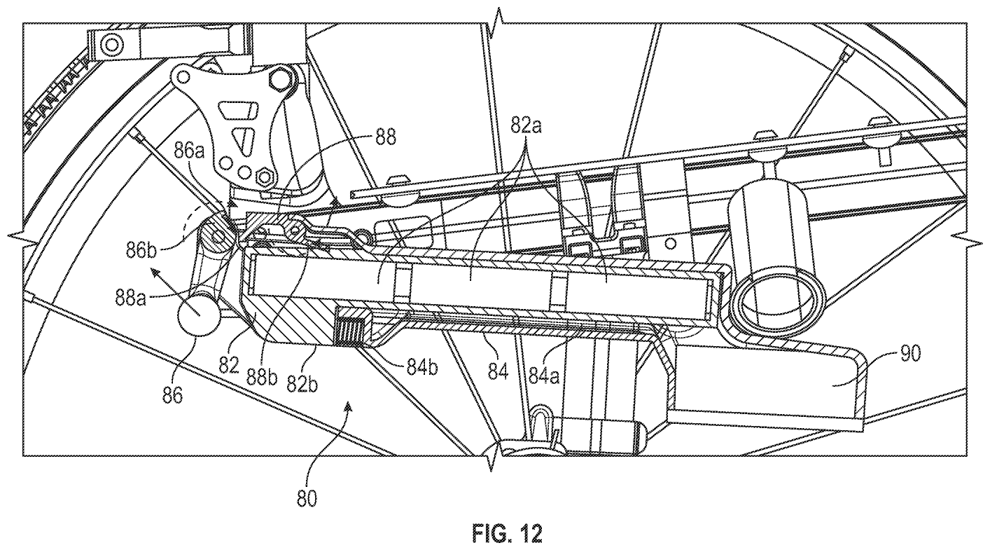

Referring now to FIGS. 11 and 12, there is illustrated a power pack and docking station, shown generally at 80. A power pack 82 is illustrated as a battery which may be any suitable source of electrical power, preferably rechargeable, and may utilize cells 82a of any battery chemistry such as, for example, lead acid, Li-ion, nickel metal hydride (NiMH), and other dry cell or wet cell battery types. The power pack 82 slides into a docking station 84 having a battery slot 84a that accepts the power pack 82. The battery slot 84a includes a contact port configured to make an electrical connection between the power pack 82 and the wheelchair electrical system. The power pack 82 may have a shoulder 82b that abuts an ejector 84b, configured as a resilient member in the docking station 84. Alternatively, the ejector 84b may be positioned in a bottom of the slot 84a. The ejector 84b biases the power pack in a disconnected state where no electrical contact is formed in order to ease extraction of the power pack from the docking station. In the illustrated embodiment, the power pack and docking station 80 are oriented in a slightly downward position to make insertion and locking into operation easier. However, any orientation may be used.

The power pack 82 includes a locking handle 86 that is pivotally mounted to the power pack housing. The locking handle 86 includes a release cam 86a that is part of a pivot or hinge 86b. As shown in FIG. 12, the release cam 86a engages a retaining latch 88 that is pivotally mounted to the docking station 84. As the locking handle is pivoted, clockwise as shown in FIG. 12, the release cam 88 contacts a latch tab 88a on the retaining latch 88 that lifts a latch finger 88b from a detent 82c of the power pack 82. Once released, the power pack 82 is partially ejected from the docking station to permit easy removal. The handle 86 is ergonomically designed for easy manipulation by users with limited or compromised motor skills. A controller 90 is illustrated as mounted at the power pack receiving end of the docking station. The controller 90 includes operational circuitry and software to permit charging, motor control, input device connectivity, and other operational aspects of the wheelchair and drive motors.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheelchair comprising;
a frame;
a camber tube attached to the frame, the camber tube defining a hollow section; and
at least one drive motor supported within the hollow section, the at least one drive motor having a motor output connected to a wheel hub.

2. The wheelchair of claim 1 wherein the wheel hub includes a release housing defining a hub drive profile, a drive ring defines a wheel drive zone that selectively engages the hub drive profile to transmit power from the at least one drive motor to the wheel hub.

3. The wheelchair of claim 2 wherein the drive ring is connected to a transfer ring by at least one actuator link, the transfer ring is selectively actuated by a control knob to move the drive ring between an engaged position where the wheel drive zone transfers power from the motor to the wheel hub and a disengaged position where the motor output is mechanically decoupled from the wheel hub.

4. The wheelchair of claim 3 wherein the actuator link is integrally connected to the transfer ring, the transfer ring including at least one drive wedge having a tapered profile, and the control knob includes mating actuation recess having a complementary tapered profile.

5. The wheelchair of claim 3 wherein the transfer ring includes a drive pin that engages the actuator link.

6. The wheelchair of claim 2 wherein a resilient member biases the transfer ring into the engaged position.

7. The wheelchair of claim 2 wherein the motor output is coupled to a drive collar defining a drive engagement zone having a torque transmitting profile and the drive ring defines a drive ring bore having a complementary torque transmitting profile that selectively engages the drive collar to transmit power from the motor to the wheel hub.

8. The wheelchair of claim 7 wherein the drive collar includes a freewheel zone defining a clearance between the drive ring bore and the drive collar such that the wheelchair drive wheels rotate freely relative to the output shaft and the wheel hub is mechanically decoupled from the motor output.

9. The wheelchair of claim 8 wherein an axle shaft engages the motor output and defines a proximal end having a torque transmitting profile that engages the drive collar and a distal end that connects to the motor output.

10. The wheelchair of claim 9 wherein the axle shaft distal end defines a torque transmitting profile having leading and exiting tapers configured to accommodate a relative angle between the axle shaft and the motor output.

11. The wheelchair of claim 9 wherein the axle shaft distal end defines a quick-release actuator comprising a ball that engages a detent to permit the axle shaft and wheel hub to be removed from the motor and camber tube.

12. The wheelchair of claim 1 wherein the camber tube supports a camber block configured to define a camber angle between the wheel hub and the camber tube.

13. The wheelchair of claim 12 wherein the camber block includes a pilot that locates relative to a motor tail housing mounted within the camber tube and a camber bore to define the camber angle.

14. The wheelchair of claim 12 wherein the camber block includes a camber bore that orients at least one support bearing to establish the camber angle, the at least one support bearing configured to orient the axle shaft to the camber angle.

15. The wheelchair of claim 1 wherein a power pack for providing a source of electrical power is configured to slide into a battery slot of a docking station, the battery slot including a contact port configured to make an electrical connection between the power pack and a wheelchair electrical system and an ejector configured to resiliently bias the power pack toward a disconnected state where no electrical connection is formed with the wheelchair electrical system.

16. A wheelchair comprising:
a frame;
a camber tube attached to the frame, the camber tube defining a hollow section; and
at least one drive motor supported within the hollow section, the at least one drive motor having an output engaged with an axle shaft at a distal end thereof, a proximal end of the axle shaft having a torque transmitting profile that engages a wheel hub to transmit a rotary output of the drive motor to the wheel hub.

17. The wheelchair of claim 16 wherein a coupling is connected to the motor output, the coupling having a torque-transmitting profile that engages with a mating torque-transmitting profile of the axle shaft distal end, the mating torque-transmitting profile configured with an apex, a leading taper and an exiting taper that permit an angular adjustment or deviation of the axle shaft relative to the output shaft.

18. The wheelchair of claim 16 wherein one of the axle shaft proximal end or axle shaft distal end defines a quick-release attachment configured as a ball and detent that is configured to release the wheel hub from the wheelchair.

19. A wheelchair comprising:
a frame;
a camber tube attached to the frame and supporting at least one drive motor having an output;
a wheel hub supporting a drive wheel for rotation relative to the frame, the wheel hub having a hub drive profile connected to the drive motor output by a drive ring configured for selectively engaging the hub drive profile to transmit power from the at least one drive motor to the drive wheel.

20. The wheelchair of claim 19 wherein the drive ring is moved by a control knob between an engaged position where the drive motor power rotates the drive wheel and a disengaged position where the drive wheel is mechanically disconnected from and freely rotates relative to the at least one drive motor.
